(19) United States
(12) Patent Application Publication
(10) Pub. No.: US 2022/0092728 A1
(43) Pub. Date: Mar. 24, 2022

(54) METHOD, SYSTEM, AND COMPUTER-READABLE MEDIUM FOR STYLIZING VIDEO FRAMES

(71) Applicant: GUANGDONG OPPO MOBILE TELECOMMUNICATIONS CORP., LTD., Dongguan (CN)

(72) Inventor: Jenhao HSIAO, Dongguan (CN)

(21) Appl. No.: 17/541,943

(22) Filed: Dec. 3, 2021

Related U.S. Application Data
(63) Continuation of application No. PCT/CN2020/090683, filed on May 15, 2020.
(60) Provisional application No. 62/859,849, filed on Jun. 11, 2019.

(51) Int. Cl. G06T 3/00; G06T 7/254; G06T 5/50; G06N 3/04

(52) U.S. Cl. CPC G06T 3/00; G06T 7/254; G06T 2207/10016; G06N 3/0454; G06T 2207/20224; G06T 5/50

(57) ABSTRACT

In an embodiment, a method includes receiving first and second images of a video sequence, wherein the first and second images are consecutive image frames; applying a style network model to the first and second images to generate first and second stylized images in a style of a style image, respectively; applying a loss network model to the first and second images, the first and second stylized images, and the style image to generate a loss function; determining a set of weights for the style network model based on the generated loss function; and stylizing the video frames using the style network model. The method can mitigate flicker artifacts between the stylized consecutive frames.

### CROSS REFERENCE TO RELATED APPLICATION

This application is a continuation application of an International Application No. PCT/CN2020/090683, filed on May 15, 2020, which claims priority to U.S. Provisional Application No. 62/859,849, filed on Jun. 11, 2019. The entire disclosures of the above applications are incorporated herein by reference.

### BACKGROUND

### 1. Field of Disclosure

The present disclosure relates to the field of image processing, and more particularly, to method, system, and computer-readable medium for stylizing video frames.

### 2. Description of Related Art

Images or videos can be recomposed in a style of a style image or a reference image using style transfer technologies. For example, stylized video frames are in the style of “The Starry Night” of Vincent van Gogh.

Video style transfer transforms the original sequence of frames into another stylized frame sequence. This can provide users a more impressive effect comparing to traditional filters, which just change color tones or color distributions. In addition, the number of style filters can be created is unlimited, which can greatly enrich the products (such as video albums) in electronic devices such as smartphones.

The techniques used in the video style transfer can be classified into image-based solutions and video-based solutions, which are described as below.

1) Image-Based Solutions

Image style transfer approaches are characterized by learning a style and applying it to other images. Briefly, the image style transfer approaches use gradient descent from white noise to synthesize an image which matches the content of a source image and the style of a reference image, respectively. A feed-forward network may be used to reduce the computation time and effectively conduct the image style transfer.

Most image-based video style transfer approaches are based on the image style transfer approaches, where they apply image-based style transfer to a video frame by frame. However, this scheme inevitably brings temporal inconsistencies in video stylization and thus causes severe flicker artifacts between consecutive stylized frames and inconsistent stylization of moving objects.

2) Video-Based Solutions

Video-based solutions try to achieve the video style transfer directly on a video domain. For example, a conventional approach is to obtain stable videos by penalizing departures from the optical flow of an input video. Style features remain present from frame to frame, following the movement of elements in the original video. However, this approach is computationally far too heavy for real-time style-transfer, taking minutes per frame.

Therefore, there is a need to solve the problems in the existing arts of this field.

### SUMMARY

An object of the present disclosure is to propose a method, system, and computer-readable medium for improving quality of stylizing video frames.

In a first aspect of the present disclosure, a method for stylizing video frames, includes: receiving a first image and a second image of a video sequence, wherein the first image and the second image are consecutive image frames; applying a style network model associated with a style image to the first image and the second image to generate a first stylized image and a second stylized image in a style of the style image, respectively; applying a loss network model to the first image, the second image, the first stylized image, the second stylized image, and the style image to generate a loss function; determining a set of weights for the style network model based on the generated loss function; and stylizing, by at least one processor, the video frames by applying the style network model with the determined set of weights to the video frames.

According to an embodiment in conjunction with the first aspect of the present disclosure, the style network model includes a first style network and a second style network, and applying the style network model to the first image and the second image includes: applying the first style network to the first image to generate the first stylized image in the style of the style image; and applying the second style network to the second image to generate the second stylized image in the style of the style image.

According to an embodiment in conjunction with the first aspect of the present disclosure, the set of weights for the style network model is determined by minimizing the loss function.

According to an embodiment in conjunction with the first aspect of the present disclosure, the loss function includes a content loss relating to how well the content of the first image matches that of the first stylized image and how well the content of the second image matches that of the second stylized image, a style loss relating to how well the first stylized image matches the style of the style image and how well the second stylized image matches the style of the style image, and a temporal loss relating to how well a motion change between the first image and the second image matches a motion change between the first stylized image and the second stylized image.

According to an embodiment in conjunction with the first aspect of the present disclosure, applying the loss network model to generate the loss function includes: generating a first content loss associated with difference between spatial features of the first image and the first stylized image and a second content loss associated with difference between spatial features of the second image and the second stylized image; generating a first style loss associated with difference between stylistic features of the first stylized image and the style image and a second style loss associated with difference between stylistic features of the second stylized image and the style image; generating a temporal loss associated with difference between a motion change between the first image and the second image and a motion change between the first stylized image and the second stylized image; and combining the first content loss, the second content loss, the first style loss, the second style loss, and the temporal loss to generate the loss function.

According to an embodiment in conjunction with the first aspect of the present disclosure, the first style loss is a squared Frobenius norm of difference between Gram matrices of the first stylized image and the style image and the second style loss is a squared Frobenius norm of difference between Gram matrices of the second stylized image and the style image.

According to an embodiment in conjunction with the first aspect of the present disclosure, the loss network model includes a first loss network and a second loss network, and applying the loss network model to generate the loss function includes: applying the first loss network to the first image and the first stylized image to generate the first content loss and applying the first loss network to the first stylized image and the style image to generate the first style loss; and applying the second loss network to the second image and the second stylized image to generate the second content loss and applying the second loss network to the second stylized image and the style image to generate the second style loss.

According to an embodiment in conjunction with the first aspect of the present disclosure, the style network model and the loss network model are convolutional neural network models.

In a second aspect of the present disclosure, a system for stylizing video frames, includes: at least one memory configured to store program instructions; at least one processor configured to execute the program instructions, which cause the at least one processor to perform steps including: receiving a first image and a second image of a video sequence, wherein the first image and the second image are consecutive image frames; applying a style network model associated with a style image to the first image and the second image to generate a first stylized image and a second stylized image in a style of the style image, respectively; applying a loss network model to the first image, the second image, the first stylized image, the second stylized image, and the style image to generate a loss function; determining a set of weights for the style network model based on the generated loss function; and stylizing the video frames by applying the style network model with the determined set of weights to the video frames.

According to an embodiment in conjunction with the second aspect of the present disclosure, the style network model includes a first style network and a second style network, and applying the style network model to the first image and the second image includes: applying the first style network to the first image to generate the first stylized image in the style of the style image; and applying the second style network to the second image to generate the second stylized image in the style of the style image.

According to an embodiment in conjunction with the second aspect of the present disclosure, the set of weights for the style network model is determined by minimizing the loss function.

According to an embodiment in conjunction with the second aspect of the present disclosure, the loss function includes a content loss relating to how well the content of the first image matches that of the first stylized image and how well the content of the second image matches that of the second stylized image, a style loss relating to how well the first stylized image matches the style of the style image and how well the second stylized image matches the style of the style image, and a temporal loss relating to how well a motion change between the first image and the second image matches a motion change between the first stylized image and the second stylized image.

According to an embodiment in conjunction with the second aspect of the present disclosure, applying the loss network model to generate the loss function includes: generating a first content loss associated with difference between spatial features of the first image and the first stylized image and a second content loss associated with difference between spatial features of the second image and the second stylized image; generating a first style loss associated with difference between stylistic features of the first stylized image and the style image and a second style loss associated with difference between stylistic features of the second stylized image and the style image; generating a temporal loss associated with difference between a motion change between the first image and the second image and a motion change between the first stylized image and the second stylized image; and combining the first content loss, the second content loss, the first style loss, the second style loss, and the temporal loss to generate the loss function.

According to an embodiment in conjunction with the second aspect of the present disclosure, the loss network model includes a first loss network and a second loss network, and applying the loss network model to generate the loss function includes: applying the first loss network to the first image and the first stylized image to generate the first content loss and applying the first loss network to the first stylized image and the style image to generate the first style loss; and applying the second loss network to the second image and the second stylized image to generate the second content loss and applying the second loss network to the second stylized image and the style image to generate the second style loss.

In a third aspect of the present disclosure, a non-transitory computer-readable medium with program instructions stored thereon, that when executed by at least one processor, cause the at least one processor to perform steps including: receiving a first image and a second image of a video sequence, wherein the first image and the second image are consecutive image frames; applying a style network model associated with a style image to the first image and the second image to generate a first stylized image and a second stylized image in a style of the style image, respectively; applying a loss network model to the first image, the second image, the first stylized image, the second stylized image, and the style image to generate a loss function; determining a set of weights for the style network model based on the generated loss function; and stylizing the video frames by applying the style network model with the determined set of weights to the video frames.

According to an embodiment in conjunction with the third aspect of the present disclosure, the style network model includes a first style network and a second style network, and applying the style network model to the first image and the second image includes: applying the first style network to the first image to generate the first stylized image in the style of the style image; and applying the second style network to the second image to generate the second stylized image in the style of the style image.

According to an embodiment in conjunction with the third aspect of the present disclosure, the set of weights for the style network model is determined by minimizing the loss function.

According to an embodiment in conjunction with the third aspect of the present disclosure, the loss function includes a content loss relating to how well the content of the first image matches that of the first stylized image and how well the content of the second image matches that of the second stylized image, a style loss relating to how well the first stylized image matches the style of the style image and how well the second stylized image matches the style of the style image, and a temporal loss relating to how well a motion change between the first image and the second image matches a motion change between the first stylized image and the second stylized image.

According to an embodiment in conjunction with the third aspect of the present disclosure, applying the loss network model to generate the loss function includes: generating a first content loss associated with difference between spatial features of the first image and the first stylized image and a second content loss associated with difference between spatial features of the second image and the second stylized image; generating a first style loss associated with difference between stylistic features of the first stylized image and the style image and a second style loss associated with difference between stylistic features of the second stylized image and the style image; generating a temporal loss associated with difference between a motion change between the first image and the second image and a motion change between the first stylized image and the second stylized image; and combining the first content loss, the second content loss, the first style loss, the second style loss, and the temporal loss to generate the loss function.

According to an embodiment in conjunction with the third aspect of the present disclosure, the loss network model includes a first loss network and a second loss network, and applying the loss network model to generate the loss function includes: applying the first loss network to the first image and the first stylized image to generate the first content loss and applying the first loss network to the first stylized image and the style image to generate the first style loss; and applying the second loss network to the second image and the second stylized image to generate the second content loss and applying the second loss network to the second stylized image and the style image to generate the second style loss.

In the present disclosure, the first image, the second image, the first stylized image, the second stylized image, and the style image are considered to construct the loss function to improve the stability of video style transfer. Instead of blindly enforcing consecutive frames to be exactly the same, the present disclosure guides the learning process of neural network by considering motion changes of source consecutive frames and stylized consecutive frames, which can mitigate flicker artifacts between the stylized consecutive frames and thus deliver much better result in stabilizing the video style transfer. Other advantages of the present disclosure include better network converge property (due to a better temporal loss) and no extra computation burden during run time.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a graphical depiction illustrating a process for training a style network model in accordance with an embodiment of the present disclosure.

FIG. 2 is a graphical depiction illustrating a deep residual convolutional neural network as an example of a style network in accordance with an embodiment of the present disclosure.

FIG. 3 is a graphical depiction illustrating a VGG-16 network as an example of a loss network in accordance with an embodiment of the present disclosure.

FIG. 4 is a flowchart of a method for stylizing video frames in accordance with an embodiment of the present disclosure.

FIG. 5 is a block diagram illustrating an electronic device for implementing video stylization in accordance with an embodiment of the present disclosure.

### DETAILED DESCRIPTION OF THE EMBODIMENTS

Embodiments of the present disclosure are described in detail with the technical matters, structural features, achieved objectives, and effects with reference to the accompanying drawings as follows. Specifically, the terminologies in the embodiments of the present disclosure are merely for describing the purpose of the certain embodiment, but not to limit the invention.

In video style transfer, the present disclosure introduces a temporal stability mechanism, which considers motion changes of source consecutive frames and stylized consecutive frames, that is, the motion changes of source and stylized are synced. This yields a better result in stabilizing the video style transfer. Unlike some conventional style transfer approaches that introduces heavy computation burden during run time, the present disclosure allows for an unruffled style transfer of videos in real-time.

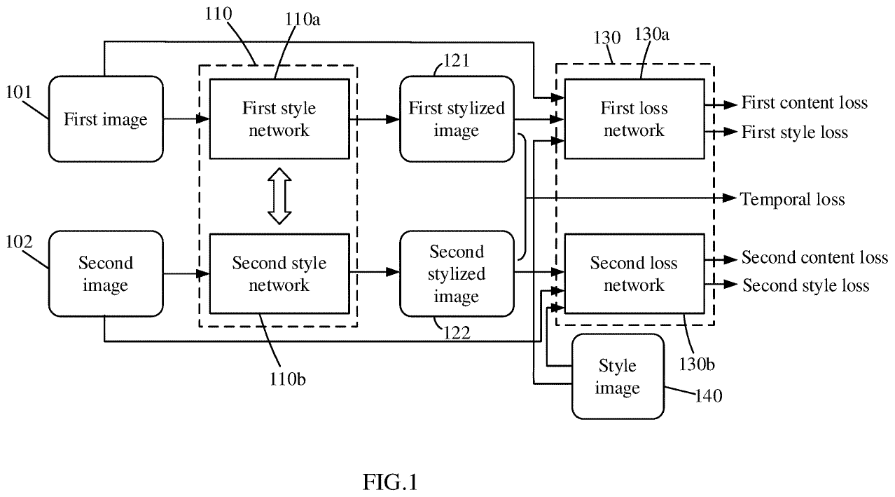

FIG. 1 is a graphical depiction illustrating a process for training a style network model in accordance with an embodiment of the present disclosure. The architecture depicted in FIG. 1 consists of two parts, that is, a style network model 110 and a loss network model 130. Video frames are fed into networks of the architecture depicted in FIG. 1 by pair and the networks will generate five losses, i.e., a first content loss, a second content loss, a first style loss, a second style loss, and a temporal loss. These losses will be used to update the style network model 110 for better video style transfer.

Video frames are fed into the style network model 110 associated with a style image or reference image 140 to generate corresponding image frames in a style of the style image or reference image 140. That is, through the style network model 110, image frames of a video are recomposed in the style of the style image or reference image 140. That is, stylized video frames and the style image have substantially same stylistic features.

As shown in FIG. 1, a video sequence includes a first image 101 (e.g., frame t) and a second image 102 (e.g., frame t+1), which are consecutive image frames. The first image 101 and the second image 102 are input into the style network model 110 to be recomposed in the style of style image 140 to generate a first stylized image 121 and a second stylized image 122, respectively.

The video frame stylization can be achieved using a single network. Alternatively, one or more style networks may be utilized in the video frame stylization for reducing the processing time. For example, the style network model 110 may include a first style network 110a and a second style network 110b. The first style network 110a is applied to the first image 101 to generate the first stylized image 121 in the style of the style image 140. The second style network 110b is applied to the second image 102 to generate the second stylized image 122 in the style of the style image 140.

For instance, the style network model 110 may be implemented by a neural network model such as a convolutional neural network (CNN), a deep neural network (DNN), a recurrent neural network (RNN), a deep residual convolutional neural network, and the like.

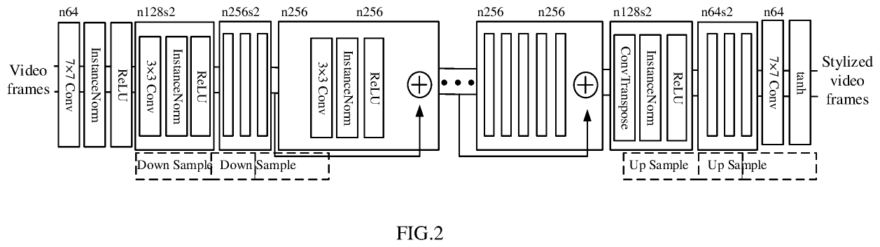

As an example, each of the first style network 110a and the second style network 110b is a deep residual convolutional neural network, as depicted in FIG. 2. The deep residual convolutional neural network includes a plurality of convolutional layers which can be classified into downsampling stages and upsampling stages. The resolution gradually decreases and the number of channels gradually increases for the convolutional layers at the downsampling stages.

The resolution gradually increases and the number of channels gradually decreases for the convolutional layers at the upsampling stages. The deep residual convolutional neural network is parameterized by weights W. Input video frames x are transformed into stylized frames y via the mapping y=fw (x). The weights W of the deep residual convolutional neural network are determined based on a loss function generated by the loss network model 130. In one embodiment, the first style network 110a and the second style network 110b may have shared weights.

The loss calculation can be achieved using a single network. Alternatively, one or more loss networks may be utilized in the loss calculation. For example, the loss network model 130 may include a first loss network 130a and a second loss network 130b. As shown in FIG. 1, the first image 101, the second image 102, the first stylized image 121, the second stylized image 122, and the style image or reference image 140 are input to the loss network model 130 to generate the loss function. Particularly, the first loss network 130a is applied to the first image 101, the first stylized image 121, and the style image 140 to generate a first content loss and a first style loss. The second loss network 130b is applied to the second image 102, the second stylized image 122, and the style image 140 to generate a second content loss and a second style loss. The first image 101, the second image 102, the first stylized image 121, and the second stylized image 122 are input into any one or both of the first loss network 130a and the second loss network 130b to generate a temporal loss. For example, the first loss network 130a generates a temporal loss relating to frames t−1 and t and the second loss network 130b generates a temporal loss relating to frames t and t+1.

As noted above, the loss function includes five losses, that is, the first content loss, the second content loss, the first style loss, the second style loss, and the temporal loss. The first content loss relates to how well the content of the first image 101 matches that of the first stylized image 121. That is, the first content loss is associated with difference between spatial features of the first image 101 and the first stylized image 121. The second content loss relates to how well the content of the second image 102 matches that of the second stylized image 122. That is, the second content loss is associated with difference between spatial features of the second image 102 and the second stylized image 122. The first style loss relates to how well the first stylized image 121 matches the style of the style image 140. That is, the first style loss is associated with difference between stylistic features of the first stylized image 121 and the style image 140. The second style loss relates to how well the second stylized image 122 matches the style of the style image 140. That is, the second style loss is associated with difference between stylistic features of the second stylized image 122 and the style image 140. The temporal loss relates to how well a motion change between the first image 101 and the second image 102 matches a motion change between the first stylized image 121 and the second stylized image 122. That is, the temporal loss is associated with difference between a motion change between the first image 101 and the second image 102 and a motion change between the first stylized image 121 and the second stylized image 122.

The loss function is generated by combining the first content loss, the second content loss, the first style loss, the second style loss, and the temporal loss. The training process is to minimize the loss function to obtain an optimized set of weights of the style network model, and the optimized set of weights are then used in the video style transfer to stylize video frames by use of the style network model, to generate stylized video frames in the style of the style image or the reference image.

Any of the loss network 130a and 130b of the loss network model 130 may be pre-trained using a set of training images obtained from the ImageNet, for example. The loss network may be any pre-trained network for image classification. The pre-trained loss network is then leveraged for training in the network architecture depicted in FIG. 1.

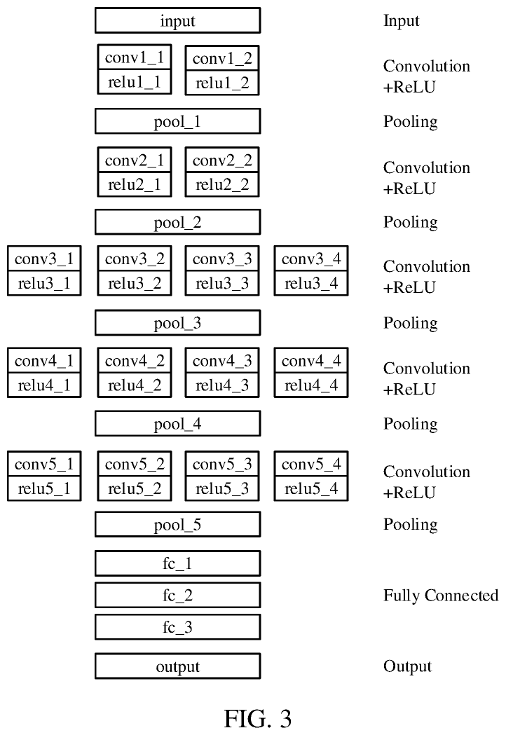

Any of the loss network 130a and 130b of the loss network model 130 may be a convolutional deep neural network pre-trained for image classification tasks. As an example, the loss network may be implemented by a well-known Visual Geometry Group (VGG) network as depicted in FIG. 3. The VGG-16 network consists of 16 convolutional layers, which include only 3×3 convolutions. It is a preferred choice because of its very uniform architecture.

The content loss, the style loss, and the temporal loss of the loss function are described in more detail as below.

1) Content Loss

Rather than encouraging the pixels of the stylized image y=fw (x) to exactly match the pixels of the input image x, they are encouraged to have similar feature representations as computed by the loss network φ. Let φⱼ (x) be the activations of the jth convolutional layer of the VGG-16 network (as shown in FIG. 3), where φⱼ (x) will be a feature map of shape Cⱼ×Hⱼ×W₁. The feature reconstruction loss is the (squared, normalized) Euclidean distance between feature representations:

L_{content}=∥φⱼ(x)−φⱼ(y)∥²/(Cⱼ×Hⱼ×Wⱼ)

2) Style Loss

Gram-matrix is used to measure which features in the style-layers activate simultaneously for the style image.

As above, let φⱼ (x) be the activations at the jth layer of the network φ for the input x, which is a feature map of shape Cⱼ×Hⱼ×Wⱼ. The Gram matrix can be defined as:

$${{G}_{j}^{ϕ} ( x )}_{c , {c}^{′}} = \frac{1}{{C}_{j} {H}_{j} {W}_{j}} {\sum }_{h = 1}^{{H}_{j}} {\sum }_{w = 1}^{{W}_{j}} {{ϕ}_{j} ( x )}_{h , w , c} {{ϕ}_{j} ( x )}_{h , w , {c}^{′}} \qquad$$

The style reconstruction loss is then the squared Frobenius norm of the difference between the Gram matrices of the stylized image y and style image s:

i L_{style}=∥Gⱼ(y)−Gⱼ(s)∥F²

As with the content representation, if there are two images whose feature maps at a given layer produce the same Gram matrix, it is expected that the two images have the same style, but not necessarily the same content. Applying this to early layers in the network would capture some of the finer textures contained within the image whereas applying this to deeper layers would capture more higher-level elements of the image's style.

3) Temporal Loss

To maintain the stability of resulted stylized frames, a temporal loss is used to enforce the consistency between pair of frames at time t and t+1. A “direct temporal loss” will be to minimize the absolute difference between stylized frames (i.e., ∥yₜ−yₜ₊₁∥²). However, it is found that this direct temporal loss cannot achieve good style transfer results due to an irrational assumption that consecutive frames are required to be exactly the same. To avoid this problem, the present disclosure proposes a temporal loss called contrastive loss, which is defined as:

Lₜₑₘₚₒᵣₐₗ=∥(Xₜ−Xₜ₊₁)−(yₜ−yₜ₊₁)∥²

The idea behind the contrastive loss is that one should consider the motion changes in the original frames and use them as a guide to update the neural network. For example, if there is a huge motion change in the original frames, then it should be expected that there is a relatively great change between the corresponding stylized frames at time t and t+1. In this case, the network is asked to output a pair of stylized frames that could be different or with motion changes (instead of blindly enforcing frames t and t+1 to be exactly the same). The contrastive loss smartly achieves this by trying to minimize the difference between the changes of original and stylized frame at time t and t+1. The information can thus correctly guide the style network to generate images depending on the source motion changes. In addition, comparing to the direct temporal loss that is hard to train, the contrastive loss guarantees a more stable neural network training process and a better converge property. The idea is easy to implement but powerful and introduce no extra computation burden to run time.

4) Total Loss

The final training objective is defined as:

$$L = {\sum }_{i ∈ \{ t , t + 1 \}} ( α {L}_{content \_ i} + β {L}_{style \_ i} ) + γ {L}_{temproal}$$

Where α, β, and γ are weighting parameters. Stochastic gradient descent may be used to minimize the loss function L to achieve the stable video style transfer.

In the present disclosure, the first image, the second image, the first stylized image, the second stylized image, and the style image are considered to construct the loss function to improve the stability of the video style transfer. Instead of blindly enforcing consecutive frames to be exactly the same, the present disclosure guides the learning process of a neural network by considering motion changes of source consecutive frames and stylized consecutive frames, which can mitigate flicker artifacts between the stylized consecutive frames and thus deliver much better results in stabilizing the video style transfer. Other advantages of the present disclosure include better network converge properties (due to a better temporal loss) and no extra computation burden during run time.

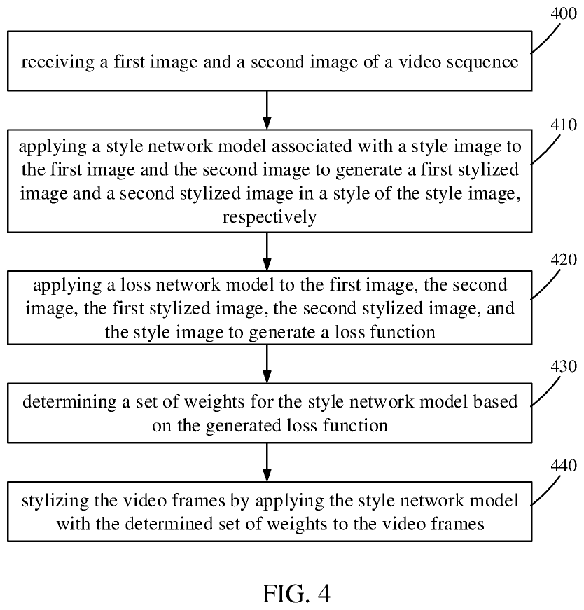

FIG. 4 is a flowchart of a method for stylizing video frames in accordance with an embodiment of the present disclosure. Referring to FIG. 4 with reference to FIGS. 1 to 3, the method includes the following blocks.

In a block 400, a first image 101 and a second image 102 of a video sequence are received by an electronic device or by at least one processor of the electronic device, for example. The first image 101 and the second image 102 are consecutive image frames, which may be transmitted from a capturing apparatus such as a camera embedded in the electronic device or placed apart from the electronic device, or obtained via wired or wireless communication, or read from an internal storage of the electronic device.

In a block 410, a style network model 110 associated with a style image 140 is applied to the first image 101 and the second image 102 to generate a first stylized image 121 and a second stylized image 122 in a style of the style image 140, respectively. That is, stylistic features of the first stylized image 121 and the second stylized image 122 are substantially as the same as that of the style image 140.

In one embodiment, the style network model 110 may include a first style network 110a and a second style network 110b. The first style network 110a is applied to the first image 101 to generate the first stylized image 121 in the style of the style image 140. The second style network 110b is applied to the second image 102 to generate the second stylized image 122 in the style of the style image 140.

In a block 420, a loss network model 130 is applied to the first image 101, the second image 102, the first stylized image 121, the second stylized image 122, and the style image 140 to generate a loss function.

In one embodiment, the loss function includes a content loss, a style loss, and a temporal loss. The content loss relates to how well the content of the first image 101 matches that of the first stylized image 121 and how well the content of the second image 102 matches that of the second stylized image 122. The style loss relates to how well the first stylized image 121 matches the style of the style image 140 and how well the second stylized image 122 matches the style of the style image 140. The temporal loss relates to how well a motion change between the first image 101 and the second image 102 matches a motion change between the first stylized image 121 and the second stylized image 122.

In one embodiment, applying the loss network model 130 to generate the loss function includes generating a first content loss associated with difference between spatial features of the first image 101 and the first stylized image 121 and a second content loss associated with difference between spatial features of the second image 102 and the second stylized image 122; generating a first style loss associated with difference between stylistic features of the first stylized image 121 and the style image 140 and a second style loss associated with difference between stylistic features of the second stylized image 122 and the style image 140; generating a temporal loss associated with difference between a motion change between the first image 101 and the second image 102 and a motion change between the first stylized image 121 and the second stylized image 122; and combining the first content loss, the second content loss, the first style loss, the second style loss, and the temporal loss to generate the loss function.

In one embodiment, the loss network model 130 includes a first loss network 130a and a second loss network 130b, and applying the loss network model 130 to generate the loss function includes: applying the first loss network 130a to the first image 101 and the first stylized image 121 to generate the first content loss and applying the first loss network 130a to the first stylized image 121 and the style image 140 to generate the first style loss; and applying the second loss network 130b to the second image 102 and the second stylized image 122 to generate the second content loss and applying the second loss network 130b to the second stylized image 122 and the style image 130 to generate the second style loss. In one embodiment, the first image 101, the second image 102, the first stylized image 121, and the second stylized image 122 are input into any one or both of the first loss network 130a and the second loss network 130b to generate a temporal loss. For example, the first loss network 130a generates a temporal loss relating to frames t−1 and t and the second loss network 130b generates a temporal loss relating to frames t and t+1.

In one embodiment, the first style loss is a squared Frobenius norm of difference between Gram matrices of the first stylized image 121 and the style image 140 and the second style loss is a squared Frobenius norm of difference between Gram matrices of the second stylized image 122 and the style image 140.

In a block 430, a set of weights for the style network model 110 is determined based on the generated loss function. In this block, the set of weights for the style network model 110 is to be optimized in the training process. The optimization of the set of weights is realized based on the generated loss function. In one embodiment, the set of weights for the style network model 110 is optimized in the training process by minimizing the loss function including the first content loss, the second content loss, the first style loss, the second style loss, and the temporal loss described above.

In a block 440, video frames are stylized by applying the style network model 110 with the determined set of weights to the video frames. The optimized set of weights for the style network model 110 are used in the video style transfer to stylize the video frames by use of the style network model 110, to generate stylized video frames in the style of the style image or the reference image 140.

The blocks 400 to 430 may be referred to steps of the training process for optimizing the set of weights for the style network model 110 whereas the block 440 may be referred to video stylization in applications.

Other details of the method are referred to related descriptions in above context, and are not repeated herein.

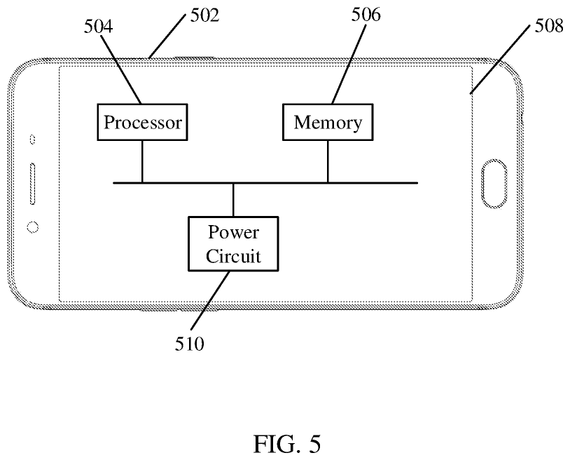

FIG. 5 is a block diagram illustrating an electronic device 500 for implementing video stylization in accordance with an embodiment of the present disclosure. For example, the electronic device 500 can be a mobile phone, a tablet device, a personal digital assistant (PDA), a game controller, or any other device having a display to present stylized video frames. The electronic device 500 depicted in FIG. 5 is for illustration purposes only. The present disclosure is not limited to any particular type of electronic devices.

Referring to FIG. 8, the electronic device 500 may include one or a plurality of the following components: a housing 502, a processor 504, a memory 506, a circuit board 508, and a power circuit 510. The circuit board 508 is disposed inside a space defined by the housing 502. The processor 504 and the memory 506 are disposed on the circuit board 508. The power circuit 510 is configured to supply power to each circuit or device of the electronic device 500. The memory 506 is configured to store executable program codes. By reading the executable program codes stored in the memory 506, the processor 504 runs a program corresponding to the executable program codes to stylize image frames of a video by use of a style network model with an optimized set of weights stored in the memory 506, to generate stylized image frames in the style of a style image or reference image. As a computer system with sufficient computational power, the electronic device 500 may be used to optimize the set of weights using steps of the method of any one of the afore-mentioned embodiments. The training or optimization steps may be carried out in a device whereas the video stylization or image transformation may be carried out in another device.

The processor 504 typically controls overall operations of the electronic device 500, such as the operations associated with display, telephone calls, data communications, camera operations, and recording operations. The processor 504 may include one or more processor 504 to execute instructions to perform actions in the above described methods. Moreover, the processor 504 may include one or more modules which facilitate the interaction between the processor 504 and other components. For instance, the processor 504 may include a multimedia module to facilitate the interaction between the multimedia component and the processor 504.

The memory 506 is configured to store various types of data to support the operation of the electronic device 500. Examples of such data include instructions for any application or method operated on the electronic device 500, contact data, phonebook data, messages, pictures, video, etc. The memory 506 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power circuit 510 supplies power to various components of the electronic device 500. The power circuit 510 may include a power management system, one or more power sources, and any other component associated with generation, management, and distribution of power for the electronic device 500.

In exemplary embodiments, the electronic device 500 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components.

In exemplary embodiments, there is also provided a non-transitory computer-readable memory medium including instructions, such as included in the memory 506, executable by the processor 504 of the electronic device 500. For example, the non-transitory computer-readable storage medium may be a ROM, a random access memory (RAM), a CD-ROM, a magnetic tape, a floppy disc, an optical data storage device, and the like.

A person having ordinary skill in the art understands that each of the units, modules, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure.

It is understood by a person having ordinary skill in the art that he/she can refer to the working processes of the system, device, and module in the above-mentioned embodiment since the working processes of the above-mentioned system, device, and module are basically the same.

For easy description and simplicity, these working processes will not be detailed.

It is understood that the disclosed system, device, and method in the embodiments of the present disclosure can be realized with other ways. The above-mentioned embodiments are exemplary only. The division of the modules is merely based on logical functions while other divisions exist in realization. It is possible that a plurality of modules or components are combined or integrated in another system. It is also possible that some characteristics are omitted or skipped. On the other hand, the displayed or discussed mutual coupling, direct coupling, or communicative coupling operate through some ports, devices, or modules whether indirectly or communicatively by ways of electrical, mechanical, or other kinds of forms.

The modules as separating components for explanation are or are not physically separated. The modules for display are or are not physical modules, that is, located in one place or distributed on a plurality of network modules. Some or all of the modules are used according to the purposes of the embodiments.

Moreover, each of the functional modules in each of the embodiments can be integrated in one processing module, physically independent, or integrated in one processing module with two or more than two modules.

If the software function module is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for stylizing video frames, comprising:
receiving a first image and a second image of a video sequence, wherein the first image and the second image are consecutive image frames;
applying a style network model associated with a style image to the first image and the second image to generate a first stylized image and a second stylized image in a style of the style image, respectively;
applying a loss network model to the first image, the second image, the first stylized image, the second stylized image, and the style image to generate a loss function;
determining a set of weights for the style network model based on the generated loss function; and
stylizing, by at least one processor, the video frames by applying the style network model with the determined set of weights to the video frames.

2. The method according to claim 1, wherein the style network model comprises a first style network and a second style network, and applying the style network model to the first image and the second image comprises:
applying the first style network to the first image to generate the first stylized image in the style of the style image; and
applying the second style network to the second image to generate the second stylized image in the style of the style image.

3. The method according to claim 1, wherein the set of weights for the style network model is determined by minimizing the loss function.

4. The method according to claim 3, wherein the loss function comprises a content loss relating to how well the content of the first image matches that of the first stylized image and how well the content of the second image matches that of the second stylized image, a style loss relating to how well the first stylized image matches the style of the style image and how well the second stylized image matches the style of the style image, and a temporal loss relating to how well a motion change between the first image and the second image matches a motion change between the first stylized image and the second stylized image.

5. The method according to claim 4, wherein applying the loss network model to generate the loss function comprises:
generating a first content loss associated with difference between spatial features of the first image and the first stylized image and a second content loss associated with difference between spatial features of the second image and the second stylized image;
generating a first style loss associated with difference between stylistic features of the first stylized image and the style image and a second style loss associated with difference between stylistic features of the second stylized image and the style image;
generating a temporal loss associated with difference between a motion change between the first image and the second image and a motion change between the first stylized image and the second stylized image; and
combining the first content loss, the second content loss, the first style loss, the second style loss, and the temporal loss to generate the loss function.

6. The method according to claim 5, wherein the first style loss is a squared Frobenius norm of difference between Gram matrices of the first stylized image and the style image and the second style loss is a squared Frobenius norm of difference between Gram matrices of the second stylized image and the style image.

7. The method according to claim 5, wherein the loss network model comprises a first loss network and a second loss network, and applying the loss network model to generate the loss function comprises:
applying the first loss network to the first image and the first stylized image to generate the first content loss and applying the first loss network to the first stylized image and the style image to generate the first style loss; and
applying the second loss network to the second image and the second stylized image to generate the second content loss and applying the second loss network to the second stylized image and the style image to generate the second style loss.

8. The method according to claim 1, wherein the style network model and the loss network model are convolutional neural network models.

9. A system for stylizing video frames, comprising:
at least one memory configured to store program instructions;
at least one processor configured to execute the program instructions, which cause the at least one processor to perform steps comprising:
receiving a first image and a second image of a video sequence, wherein the first image and the second image are consecutive image frames;
applying a style network model associated with a style image to the first image and the second image to generate a first stylized image and a second stylized image in a style of the style image, respectively;
applying a loss network model to the first image, the second image, the first stylized image, the second stylized image, and the style image to generate a loss function;
determining a set of weights for the style network model based on the generated loss function; and
stylizing the video frames by applying the style network model with the determined set of weights to the video frames.

10. The system according to claim 9, wherein the style network model comprises a first style network and a second style network, and applying the style network model to the first image and the second image comprises:
applying the first style network to the first image to generate the first stylized image in the style of the style image; and
applying the second style network to the second image to generate the second stylized image in the style of the style image.

11. The system according to claim 9, wherein the set of weights for the style network model is determined by minimizing the loss function.

12. The system according to claim 11, wherein the loss function comprises a content loss relating to how well the content of the first image matches that of the first stylized image and how well the content of the second image matches that of the second stylized image, a style loss relating to how well the first stylized image matches the style of the style image and how well the second stylized image matches the style of the style image, and a temporal loss relating to how well a motion change between the first image and the second image matches a motion change between the first stylized image and the second stylized image.

13. The system according to claim 12, wherein applying the loss network model to generate the loss function comprises:
generating a first content loss associated with difference between spatial features of the first image and the first stylized image and a second content loss associated with difference between spatial features of the second image and the second stylized image;
generating a first style loss associated with difference between stylistic features of the first stylized image and the style image and a second style loss associated with difference between stylistic features of the second stylized image and the style image;
generating a temporal loss associated with difference between a motion change between the first image and the second image and a motion change between the first stylized image and the second stylized image; and
combining the first content loss, the second content loss, the first style loss, the second style loss, and the temporal loss to generate the loss function.

14. The system according to claim 13, wherein the loss network model comprises a first loss network and a second loss network, and applying the loss network model to generate the loss function comprises:
applying the first loss network to the first image and the first stylized image to generate the first content loss and applying the first loss network to the first stylized image and the style image to generate the first style loss; and
applying the second loss network to the second image and the second stylized image to generate the second content loss and applying the second loss network to the second stylized image and the style image to generate the second style loss.

15. A non-transitory computer-readable medium with program instructions stored thereon, that when executed by at least one processor, cause the at least one processor to perform steps comprising:
receiving a first image and a second image of a video sequence, wherein the first image and the second image are consecutive image frames;
applying a style network model associated with a style image to the first image and the second image to generate a first stylized image and a second stylized image in a style of the style image, respectively;
applying a loss network model to the first image, the second image, the first stylized image, the second stylized image, and the style image to generate a loss function;
determining a set of weights for the style network model based on the generated loss function; and
stylizing the video frames by applying the style network model with the determined set of weights to the video frames.

16. The non-transitory computer-readable medium according to claim 15, wherein the style network model comprises a first style network and a second style network, and applying the style network model to the first image and the second image comprises:
applying the first style network to the first image to generate the first stylized image in the style of the style image; and
applying the second style network to the second image to generate the second stylized image in the style of the style image.

17. The non-transitory computer-readable medium according to claim 15, wherein the set of weights for the style network model is determined by minimizing the loss function.

18. The non-transitory computer-readable medium according to claim 17, wherein the loss function comprises a content loss relating to how well the content of the first image matches that of the first stylized image and how well the content of the second image matches that of the second stylized image, a style loss relating to how well the first stylized image matches the style of the style image and how well the second stylized image matches the style of the style image, and a temporal loss relating to how well a motion change between the first image and the second image matches a motion change between the first stylized image and the second stylized image.

19. The non-transitory computer-readable medium according to claim 18, wherein applying the loss network model to generate the loss function comprises:
generating a first content loss associated with difference between spatial features of the first image and the first stylized image and a second content loss associated with difference between spatial features of the second image and the second stylized image;
generating a first style loss associated with difference between stylistic features of the first stylized image and the style image and a second style loss associated with difference between stylistic features of the second stylized image and the style image;
generating a temporal loss associated with difference between a motion change between the first image and the second image and a motion change between the first stylized image and the second stylized image; and
combining the first content loss, the second content loss, the first style loss, the second style loss, and the temporal loss to generate the loss function.

20. The non-transitory computer-readable medium according to claim 19, wherein the loss network model comprises a first loss network and a second loss network, and applying the loss network model to generate the loss function comprises:
applying the first loss network to the first image and the first stylized image to generate the first content loss and applying the first loss network to the first stylized image and the style image to generate the first style loss; and
applying the second loss network to the second image and the second stylized image to generate the second content loss and applying the second loss network to the second stylized image and the style image to generate the second style loss.
